(19) United States
(12) Patent Application Publication
(10) Pub. No.: US 2025/0356853 A1
(43) Pub. Date: Nov. 20, 2025

(54) SPEECH RECOGNITION DEVICE, SPEECH RECOGNITION METHOD, AND STORAGE MEDIUM

(71) Applicant: HONDA MOTOR CO., LTD., Tokyo (JP)

(72) Inventors: Yui Sudo, Wako-shi (JP); Yosuke Fukumoto, Tokyo (JP)

(21) Appl. No.: 19/195,747

(22) Filed: May 1, 2025

(30) Foreign Application Priority Data
May 20, 2024 (JP) 2024-081768

(51) Int. Cl. G10L 15/22; G06N 3/0455; G10L 15/08; G10L 15/16

(52) U.S. Cl. CPC G10L 15/22; G06N 3/0455; G10L 15/16; G10L 2015/088

(57) ABSTRACT

A speech recognition device includes an acquisition unit configured to acquire audio data of an utterance and a speech recognition unit configured to generate text from the audio data using an automatic speech recognition model. The automatic speech recognition model includes an audio encoder configured to convert the audio data into a feature, a bias encoder configured to convert a registered bias token into a feature, and a bias decoder expanded to correspond to a bias token and configured to estimate the next token on the basis of a feature output by the audio encoder, a feature output by the bias encoder, and a previously estimated token sequence.

### CROSS-REFERENCE TO RELATED APPLICATION

This application is based upon and claims the benefit of priority from Japanese Patent Application No. 2024-081768, filed May 20, 2024, the entire content of which is incorporated herein by reference.

### BACKGROUND

### Field of the Invention

The present invention relates to a speech recognition device, a speech recognition method, and a storage medium.

### Description of Related Art

In speech recognition technology, an end-to-end (E2E) model has been attracting attention as an alternative to a conventional deep neural network (DNN)-hidden Markov model (HMM) model. In the DNN-HMM model, an acoustic model and a language model are connected in cascade for processing, which causes the problem of error accumulation. On the other hand, because the E2E model outputs text directly from speech features, it has been reported that the whole is optimized and the recognition rate is improved.

### SUMMARY

However, because conventional E2E models do not use dictionaries, the entire model is required to be retrained to recognize words that appear infrequently, such as personal names, and it is not possible to easily register personal names or terms and the like.

The present invention has been made in consideration of these circumstances and an objective of the present invention is to provide a speech recognition device, a speech recognition method, and a storage medium for enabling the accuracy of speech recognition to be further improved by using an E2E-automatic speech recognition (ASR) model that can easily register words, phrases, and sentences that appear infrequently.

A speech recognition device, a speech recognition method, and a storage medium according to the present invention adopt the following configurations.
(1) According to a first example of the present invention, there is provided a speech recognition device including: an acquisition unit configured to acquire audio data of an utterance; and a speech recognition unit configured to generate text from the audio data using an automatic speech recognition model, wherein the automatic speech recognition model includes a first encoder configured to convert a first feature sequence in which features of the audio data are arranged into a second feature sequence; a second encoder configured to register any one or a combination of pre-registered words, phrases, and sentences as a first token and convert a first token sequence in which first tokens are arranged into a third feature sequence; and a decoder expanded to correspond to the first token and configured to estimate the second token or the first token following a second token sequence in which at least one of the first token and a second token different from the first token previously estimated as the text is arranged on the basis of the second feature sequence, the third feature sequence, and the second token sequence.
(2) According to a second example of the present invention, in the first example, the decoder has an embedding layer expanded to correspond to the first token, and the embedding layer determines whether or not the second token sequence includes the first token, converts the second token sequence into a fourth feature sequence when the second token sequence does not include the first token, converts the remaining second token sequence, excluding the first token, into the fourth feature sequence when the second token sequence includes the first token, and generates a fifth feature sequence by concatenating a third feature corresponding to the first token included in the second token sequence among a plurality of third features included in the third feature sequence and the fourth feature sequence after conversion of the remaining second token sequence, excluding the first token.
(3) According to a third example of the present invention, in the second example, the decoder has an output layer expanded to correspond to the first token, and the output layer converts the fourth feature sequence or the fifth feature sequence into a sixth feature sequence, calculates a first score that is a score of the first token on the basis of an inner product of the sixth feature sequence and the first token sequence, calculates a second score that is a score of each of the second tokens included in the second token sequence, and calculates a probability of the second token or the first token following the second token sequence on the basis of the first score and the second score.
(4) According to a fourth example of the present invention, in the first or second example, the speech recognition device further includes an input interface capable of being manipulated by a user, wherein the speech recognition unit registers any one or a combination of the words, phrases, and sentences input by the user to the input interface as the first token.
(5) According to a fifth example of the present invention, there is provided a speech recognition method using a computer, including: acquiring audio data of an utterance; and generating text from the audio data using an automatic speech recognition model, wherein the automatic speech recognition model includes a first encoder configured to convert a first feature sequence in which features of the audio data are arranged into a second feature sequence; a second encoder configured to register any one or a combination of pre-registered words, phrases, and sentences as a first token and convert a first token sequence in which first tokens are arranged into a third feature sequence; and a decoder expanded to correspond to the first token and configured to estimate the second token or the first token following a second token sequence in which at least one of the first token and a second token different from the first token previously estimated as the text is arranged on the basis of the second feature sequence, the third feature sequence, and the second token sequence.
(6) According to a sixth example of the present invention, there is provided a non-transitory storage medium storing a program for causing a computer to: acquire audio data of an utterance; and generate text from the audio data using an automatic speech recognition model, wherein the automatic speech recognition model includes a first encoder configured to convert a first feature sequence in which features of the audio data are arranged into a second feature sequence; a second encoder configured to register any one or a combination of pre-registered words, phrases, and sentences as a first token and convert a first token sequence in which first tokens are arranged into a third feature sequence; and a decoder expanded to correspond to the first token and configured to estimate the second token or the first token following a second token sequence in which at least one of the first token and a second token different from the first token previously estimated as the text is arranged on the basis of the second feature sequence, the third feature sequence, and the second token sequence.

According to the above example, the accuracy of speech recognition can be further improved by using an E2E-ASR model that can easily register words, phrases, and sentences that appear infrequently.

### BRIEF DESCRIPTION OF THE DRAWINGS

FIG. 1 is a configuration diagram of a speech recognition device according to an embodiment.

5 FIG. 2 is a flowchart showing a flow of an inference process of a processing unit according to an embodiment.

FIG. 3 is a diagram showing an example of a configuration of an E2E-ASR model according to an embodiment.

FIG. 4 is a diagram showing an example of a configuration of an expanded embedding layer of a bias decoder.

FIG. 5 is a diagram showing an example of a configuration of an expanded output layer of the bias decoder.

FIG. 6 is a diagram showing another example of the configuration of the E2E-ASR model according to an embodiment.

FIG. 7 is a diagram showing another example of the configuration of the E2E-ASR model according to an embodiment.

FIG. 8 is a flowchart showing a flow of a training process of a processing unit according to an embodiment.

FIG. 9 is a diagram showing an example of experimental results of an offline connectionist temporal classification (CTC)/attention-based model.

FIG. 10 is a diagram showing results of a cumulative log probability defined by Eq. (15).

FIG. 11 is a diagram showing results of the effect of bias weights.

FIG. 12 is a diagram showing results when N (=203) technical terms are registered in a bias list B.

FIG. 13 is a diagram showing results of a streaming recurrent neural network-transducer (RNN-T)-based model using a bias list of size N=100.

### DESCRIPTION OF EMBODIMENTS

Embodiments of a speech recognition device, speech recognition method, and storage medium of the present invention will be described below with reference to the drawings.

### Configuration of Speech Recognition Device

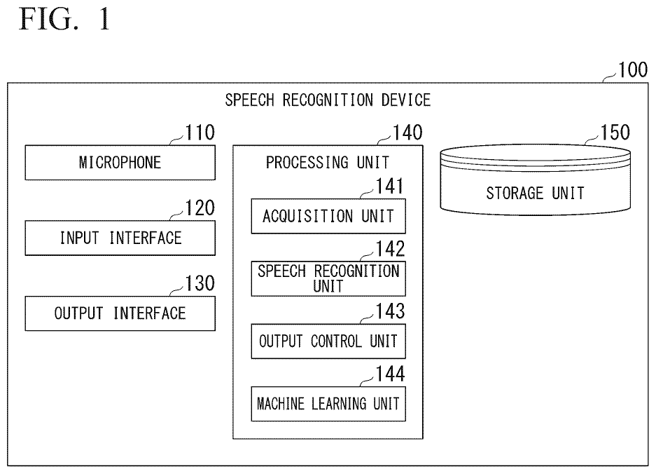

FIG. 1 is a configuration diagram of a speech recognition device 100 according to an embodiment. The speech recognition device 100 may be a single device or may be a system in which a plurality of devices connected via a network NW such as a local area network (LAN) or a wide area network (WAN) operate in cooperation with each other. That is, the speech recognition device 100 may be implemented by a plurality of computers (processors) included in a distributed computing system or a cloud computing system.

The speech recognition device 100 includes, for example, a microphone 110, an input interface 120, an output interface 130, a processing unit 140, and a storage unit 150.

The microphone 110 collects speech uttered by the user and outputs data indicating the speech (hereinafter referred to as audio data) to the processing unit 140. Although the utterance here typically refers to an utterance of a human (a user), the present invention is not limited thereto. The utterance may be, for example, an artificial utterance produced by a robot, a machine, or a computer. In other words, the utterance may be an artificial utterance produced by speech synthesis technology.

The input interface 120 receives various types of input manipulations from the user, converts the received input manipulations into electrical signals, and outputs the electrical signals to the processing unit 140. For example, the input interface 120 is a mouse, a keyboard, a trackball, a switch, a button, a joystick, a touch panel, or the like.

For example, the user may input any one or a combination of words, phrases, and sentences to the input interface 120. These are registered as dynamic bias tokens to be described below.

The output interface 130 includes, for example, a display, a speaker, and the like. The display displays images generated by the processing unit 140 and a graphical user interface (GUI) for receiving various types of input manipulations from the user and the like. For example, the display is a liquid crystal display (LCD), an organic electroluminescence (EL) display, or the like. The speaker outputs information input from the processing unit 140 as a sound. When the input interface 120 is a touch panel, the input interface 120 and the output interface 130 may be integrally configured.

The processing unit 140 includes, for example, an acquisition unit 141, a speech recognition unit 142, an output control unit 143, and a machine learning unit 144. Constituent elements of the processing unit 140 are implemented by a processor such as a central processing unit (CPU) or a graphics processing unit (GPU) executing a program stored in the storage unit 150. Moreover, the constituent elements of the processing unit 140 may be implemented by hardware such as a large-scale integration (LSI) circuit, an application-specific integrated circuit (ASIC), a field programmable gate array (FPGA), or a system on chip (SOC) or may be implemented by software and hardware in cooperation.

The processing unit 140 uses an end-to-end automatic speech recognition model (hereinafter referred to as an E2E-ASR model) to generate text data representing content of the utterance from audio data (also referred to as an audio stream). The text data includes a token sequence representing the content of the utterance. Details of the E2E-ASR model will be described below.

The storage unit 150 is implemented by, for example, a hard disk drive (HDD), a flash memory, an electrically erasable programmable read-only memory (EEPROM), a read-only memory (ROM), a random-access memory (RAM), or the like. The storage unit 150 stores firmware, application programs, and the like. Furthermore, the storage unit 150 stores a program, an algorithm, or an architecture that defines the E2E-ASR model.

### Processing Flow: Inference

Processing content of each constituent element of the processing unit 140 will be described below using a flowchart. FIG. 2 is a flowchart showing a flow of an inference process of the processing unit 140 according to an embodiment. The process of this flowchart may be executed iteratively at predetermined intervals.

First, the acquisition unit 141 acquires audio data of an utterance from the microphone 110 (step S100).

Subsequently, the speech recognition unit 142 generates text data from the audio data using the E2E-ASR model (step S102).

Subsequently, the output control unit 143 outputs the text data via the output interface 130 (step S104). For example, the output control unit 143 may display the text data on the display of the output interface 130 or may output the text data as speech from the speaker of the output interface 130.

Subsequently, the acquisition unit 141 determines whether or not the utterance has ended (step S106). For example, the acquisition unit 141 may perform utterance segment detection (voice activity detection (VAD)) on the audio data and determine whether the utterance has ended on the basis of a result of the utterance segment detection.

When the utterance has not ended, the acquisition unit 141 acquires audio data of the utterance following the previous utterance.

On the other hand, when the utterance has ended, the process of this flowchart ends.

### General E2E-ASR Model

Before the description of the E2E-ASR model of the present embodiment, the general E2E-ASR model will be described with mathematical formulas.

The general E2E-ASR model includes an encoder and a decoder, for example, as described in Reference Documents 1 and 2.

Reference Document 1: R. Prabhavalkar, T. Hori, T. N. Sainath, R. Schluter, and S. Watanabe, “End-to-End Speech Recognition: A survey,” IEEE/ACM Transactions on Audio, Speech, and Language Processing, vol. 32, pp. 325 to 351, 2023.

Reference Document 2: J. Li et al., “Recent Advances in End-to-End Automatic Speech Recognition,” APSIPA Transactions on Signal and Information Processing, vol. 11, no. 1, 2022.

### Encoder

The encoder includes, for example, two convolutional layers, a linear projection layer, and Mₐ conformer blocks. The conformer block converts a feature sequence X, which is a sequence of multiple features of audio data, into a T-length hidden state vector sequence H=[hᵢ, . . . , h_{T}]∈R^{d×T}. Here, d denotes a dimension. The hidden state vector sequence H is expressed, for example, by Eq. (1).

$$H = AudioEnc ( X ) \qquad ( 1 )$$

### Decoder

H (i.e., a hidden state vector sequence H) generated by the encoder and a previously estimated token sequence y_{0:s-1}=[yₒ, . . . , yₛ₋₁] are input to the decoder. When the vector sequence H and the token sequence y_{0:s-1} are input, the decoder recursively estimates the next token yₛ as shown in Eq. (2). In other words, the decoder estimates the token yₛ that follows the token sequence y_{0:s-1}.

$$P ( {y}_{s} \vert {y}_{0 : s - 1} , X ) = Decoder ( {y}_{0 : s - 1} , H ) \qquad ( 2 )$$

Here, yₛ denotes an s^{th} subword-level token in a predefined static vocabulary Vⁿ of size K (yₛ∈Vⁿ). The decoder includes, for example, an embedding layer, M_{d} transformer blocks, and an output layer.

First, the embedding layer using positional encoding converts the input token sequence y_{0:s-1} into an embedding vector sequence E_{0:s-1}=[e₀, . . . , eₛ₋₁]∈R^{d×s} as shown in Eq. (3).

$${E}_{0 : s - 1} = Embedding ( {y}_{0 : s - 1} ) \qquad ( 3 )$$

Subsequently, the embedding vector sequence E_{0:s-1} is input to the M_{d} transformer blocks together with the hidden state vector sequence H of Eq. (1). When E_{0:s-1} and H are input to the transformer block, a hidden state vector uₛ is generated as shown in Eq. (4).

$${u}_{s} = Transformer ( {E}_{0 : s - 1} , H ) \qquad ( 4 )$$

Subsequently, a score

$${α}^{n} = [ {α}_{1}^{n} , … , {α}_{K}^{n} ]$$

for each token is calculated according to Eq. (5), and a probability P corresponding to the score is calculated according to Eq. (6).

$${α}^{n} = Linear ( {u}_{s} ) \qquad ( 5 )$$

$$P ( {y}_{s} \vert {y}_{0 : s - 1} , X ) = Softmax ( {α}^{n} ) \qquad ( 6 )$$

By recursively iterating these processes, a posterior probability P is formulated as shown in Eq. (7).

$$P ( {y}_{0 : S} \vert X ) = {\prod }_{s = 1}^{S} P ( {y}_{s} \vert {y}_{0 : s - 1} , X ) \qquad ( 7 )$$

Here, S denotes the total number of tokens. Parameters of the model (weighting coefficients, bias components, and the like) are optimized by minimizing a negative log-likelihood as shown in Eq. (8).

$$L = - log P ( {y}_{0 : S} \vert X ) \qquad ( 8 )$$

In the present embodiment, the embedding layer and output layer of this decoder are expanded by a biasing method to be described below.

### E2E-ASR Model of Present Embodiment

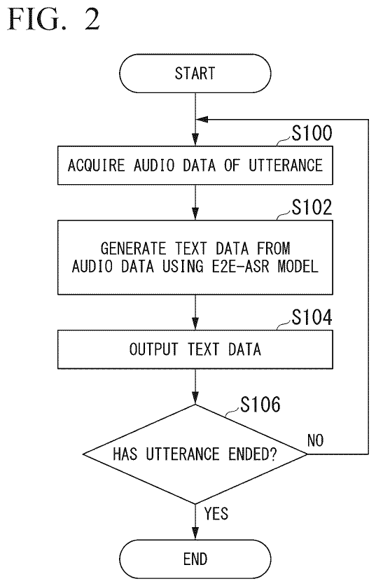

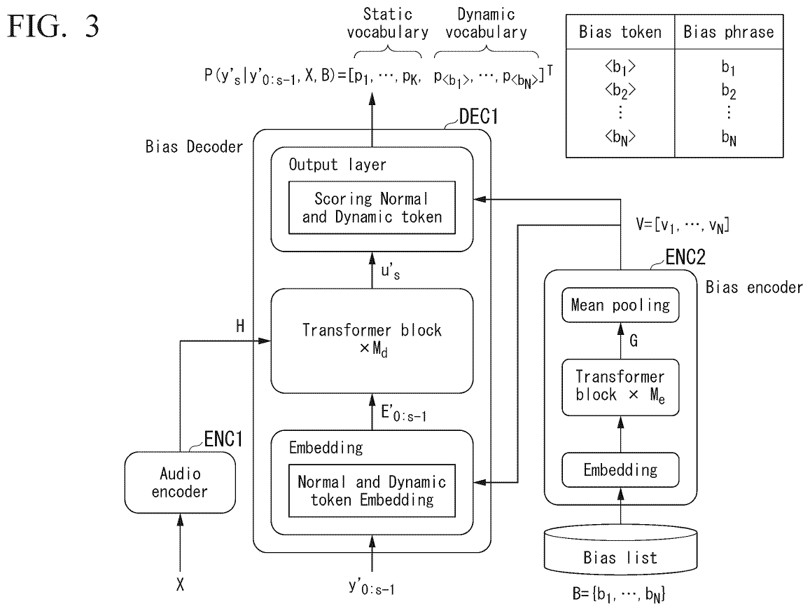

Next, a configuration of the E2E-ASR model according to the present embodiment will be described. FIG. 3 is a diagram showing an example of the configuration of the E2E-ASR model according to the present embodiment. In the present embodiment, the E2E-ASR model in which a dynamic vocabulary that can add a bias token at a word level, a phrase level, or a sentence level is introduced is adopted. The E2E-ASR model according to the present embodiment includes, for example, an audio encoder ENC1, a bias encoder ENC2, and a bias decoder DEC1. Because the audio encoder ENC1 is the same as the encoder of the general E2E-ASR model described above, description thereof will be omitted here. The audio encoder ENC1 is an example of a “first encoder” and the bias encoder ENC2 is an example of a “second encoder.”

### Bias Encoder

The bias encoder ENC2 includes, for example, an embedding layer, Mₑ transformer blocks, an average pooling layer, and a bias list B={b₁, . . . , b_{N}}.

The bias list B is, for example, a list in which any one or a combination of words, phrases, and sentences input to the input interface 120 is registered as a dynamic bias token. Hereinafter, as an example, it is assumed that phrases are registered as dynamic bias tokens in the bias list B.

For example, bₙ∈Vⁿ included in the bias list B is a I-length subword token sequence of an n^{th} bias phrase (for example, [<N>, <el>, <ly>]).

The bias encoder ENC2 converts the bias list B into a matrix B∈R^{Lmax×xN} through zero padding on the basis of a maximum token length Iₘₐₓ of the bias list B. Subsequently, the embedding layer and Mₑ transformer blocks in the bias encoder ENC2 extract a high-level representation G∈R^{dx×Lmax×xN} as shown in Eq. (9).

$$G = TransformerEnc ( Embedding ( B ) ) \qquad ( 9 )$$

Subsequently, the average pooling layer extracts a phrase-level embedding vector V=[V₁, . . . , V_{N}]∈R^{d×N} as shown in Eq. (10).

$$V = MeanPool ( G ) \qquad ( 10 )$$

### Bias Decoder Including Dynamic Vocabulary

A dynamic vocabulary V^{b}={<b₁>, . . . , <b_{N}>} is introduced to the bias decoder DEC1 to avoid the complexity of a learning dependency relationship within bias phrases.

Here, the phrase-level bias token represents a bias phrase with N single entities (such as proper nouns, personal names, or coined words) in the bias list B.

Unlike the above Eq. (2), the bias decoder DEC1 estimates the next token

$${y}_{s}^{′} ∈ \{ {V}^{n} ⋃ {V}^{b} \}$$

when H in Eq. (1), V in Eq. (10), and

$${y}_{0 : s - 1}^{′}$$

in the following Eq. (11) are given.

$${{{1}^{⊃} ( 1 {j}_{6} ′ {\vert}_{e} ′ 7 ]}_{0} : i 〉}^{∼ ⋅ 1} , X , B ) - {f}_{J}^{⊃} {i}_{c} {a}_{∖}^{∖} I \check{J} e {⊂}_{=} o {d}_{{k}^{x} 1 '} ( 1 {j}_{∖ j : b - 1} ′ ; H , l f ) \qquad ( 11 )$$

For example, if a proper noun referred to as “Nelly” is registered in the bias list B as a bias phrase, the bias decoder DEC1 outputs the corresponding bias token [<Nelly>] instead of the normal token sequence [<N>, <el>, <ly>].

The bias decoder DEC1 includes an expanded embedding layer, M_{d} transformer blocks, and an expanded output layer.

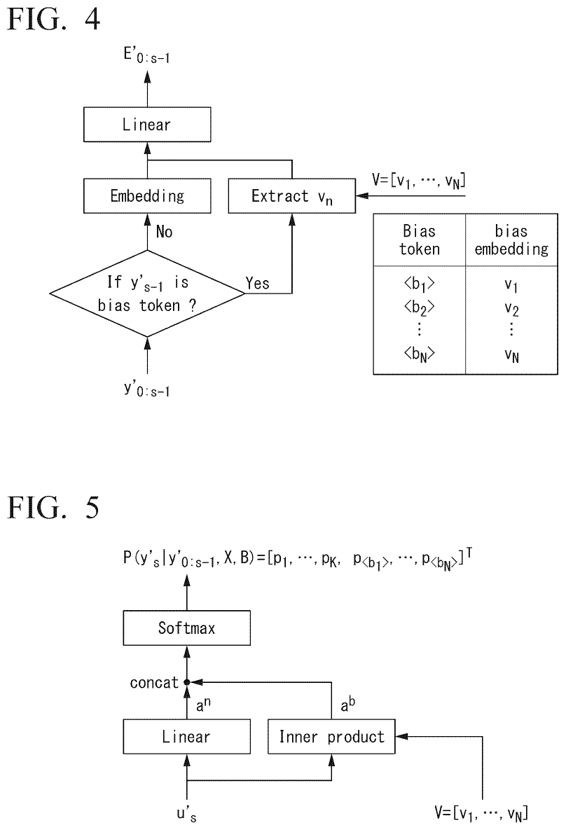

FIG. 4 shows an example of a configuration of the expanded embedding layer of the bias decoder DEC1. FIG. 5 shows an example of the configuration of the expanded output layer of the bias decoder DEC1.

First, the expanded embedding layer of the bias decoder DEC1 converts the input token sequence

$${y}_{0 : s - 1}^{′}$$

into an embedding vector sequence

$${E}_{0 : s - 1}^{′} = [ {e}_{0}^{′} , … , {e}_{s - 1}^{′} ] ∈ {R}^{d \times s} .$$

Unlike Eq. (3), the expanded embedding layer determines whether or not the input token

$${y}_{s - 1}^{′}$$

is the same as any one of the bias tokens registered in the bias list B. The input token sequence

$${y}_{0 : s - 1}^{′}$$

is an example of a “second token sequence” and the token included in the token sequence

$${y}_{0 : s - 1}^{′}$$

is an example of a “second token.” The bias token registered in the bias list B is an example of a “first token sequence.”

When the input token

$${y}_{s - 1}^{′}$$

is the same as tie bias token, the expanded embedding layer extracts the corresponding bias embedding vector vₙ from a collection V of bias embedding vectors (see FIG. 4). The corresponding bias embedding vector vₙ is an example of a “third feature” and the collection V of bias embedding vectors is an example of a “third feature sequence.”

On the other hand, when the input token

$${y}_{s - 1}^{′}$$

is different from the bias token, the expanded embedding layer converts the input token

$${y}_{s - 1}^{′}$$

into an embedding vector

$${e}_{s - 1}^{′} .$$

The embedding vector

$${e}_{s - 1}^{′}$$

of the token

$${y}_{s - 1}^{′}$$

is an example of a “fourth feature.”

Also, as shown in Eq. (12), the expanded embedding layer uses a linear layer to output an embedding vector sequence

$${E}_{0 : s - 1}^{′}$$

including only the embedding

$${e}_{s - 1}^{′}$$

of the token

$${y}_{s - 1}^{′}$$

or an embedding vector sequence

$${E}_{0 : s - 1}^{′}$$

including the embedding vector

$${e}_{s - 1}^{′}$$

of the token

$${y}_{s - 1}^{′}$$

and the bias embedding vector vₙ.

$${e}_{s - 1}^{′} = \{ \begin{matrix}Linear ( Extract ( V , {y}_{s - 1}^{′} ) ) & ( {y}_{s - 1}^{′} ∈ {𝒱}^{b} ) \\ Linear ( Embedding ( {y}_{s - 1}^{′} ) ) & ( {y}_{s - 1}^{′} ∈ {𝒱}^{n} )\end{matrix} \qquad ( 12 )$$

In the above process, in other words, the expanded embedding layer determines whether or not the input token sequence

$${y}_{0 : s - 1}^{′}$$

includes a bias token.

When the input token sequence

$${y}_{0 : s - 1}^{′}$$

includes a bias token, the expanded embedding layer extracts the bias embedding vector vₙ corresponding to the bias token included in the input token sequence

$${y}_{0 : s - 1}^{′}$$

from a collection V of bias embedding vectors. The expanded embedding layer converts each token

$${y}_{s - 1}^{′}$$

of the remaining token sequence

$${y}_{0 : s - 1}^{′} ,$$

excluding the bias token, into an embedding vector

$${e}_{s - 1}^{′} .$$

Also, the expanded embedding layer outputs an embedding vector sequence

$${E}_{0 : s - 1}^{′}$$

obtained by concatenating the embedding vector

$${e}_{s - 1}^{′}$$

of the token

$${y}_{s - 1}^{′}$$

with the bias embedding vector vₙ. The embedding vector sequence

$${E}_{0 : s - 1}^{′}$$

obtained by concatenating the embedding vector

$${e}_{s - 1}^{′}$$

of the token

$${y}_{s - 1}^{′}$$

is an example of a “fourth feature sequence.” The embedding vector sequence

$${E}_{0 : s - 1}^{′}$$

obtained by concatenating the embedding vector

$${e}_{s - 1}^{′}$$

of the token

$${y}_{s - 1}^{′}$$

with the bias embedding vector vₙ is an example of a “fifth feature sequence.”

On the other hand, when the input token sequence

$${y}_{0 : s - 1}^{′}$$

does not include a bias token, the expanded embedding layer converts all tokens

$${y}_{s - 1}^{′}$$

included in the token sequence

$${y}_{0 : s - 1}^{′}$$

into embedding vectors

$${e}_{s - 1}^{l}$$

and outputs the embedding vector sequence

$${E}_{0 : s - 1}^{′}$$

obtained by concatenating them.

Subsequently, the M_{d} transformer blocks convert the embedding vector sequence

$${E}_{0 : s - 1}^{′}$$

into a hidden state vector

$${u}_{s}^{′}$$

as shown in Eq. (4). The M_{d} transformer blocks calculate the bias token score

$${α}^{b} = [ {a}_{1}^{b} , … , {a}_{N}^{b} ]$$

as shown in Eq. (13) using an inner product, in addition to the score αⁿ for each normal token that is not a bias token as shown in Eq. (5) (see FIG. 5). The hidden state vector

$${u}_{s}^{′}$$

is all example of a “sixth feature sequence.”

$$α = \frac{{u}_{s}^{′} {V}^{T}}{\sqrt{d}} \qquad ( 13 )$$

The bias token score α^{b} is concatenated with the normal token score αⁿ to obtain

$$α = [ {a}_{1}^{n} , … , {a}_{K}^{n} , {a}_{1}^{b} , … , {a}_{N}^{b} ] .$$

Subsequently, the probability P of each token including a bias token is calculated by the softmax function as shown in Eq. (14). The bias token score α^{b} is an example of a “first score” and the normal token score αⁿ is an example of a “second score.”

$$P ( {y}_{s}^{′} \vert {y}_{0 : s - 1}^{′} , X , B ) = Softmax ( Concat ( {α}^{n} , {α}^{b} ) ) \qquad ( 14 )$$

Like Eqs. (7) and (8), the posterior probability is formulated as shown in Eq. (15), and the loss function is formulated as shown in Eq. (16). In other words, the posterior probability becomes [p₁, . . . , p_{K}, p_{<b1>}, . . . , p_{<bN>}].

$$P ( {y}_{0 : {S}^{′}}^{′} \vert X , B ) = {\prod }_{s = 1}^{{S}^{′}} P ( {y}_{s}^{′} \vert {y}_{0 : s - 1}^{′} , X , B ) \qquad ( 15 )$$

$${L}^{′} = - log P ( {y}_{0 : {S}^{′}}^{′} \vert X , B ) \qquad ( 16 )$$

Here, S′ denotes the total number of tokens based on bias tokens. Eqs. (13) and (14) are flexible to the size N of the bias list B, and can be optimized using the loss function of Eq. (16) without auxiliary loss.

### Weight of Bias During Inference

When practicality is considered, a bias weighting coefficient such as Eq. (17) may be introduced into Eq. (14) to avoid excess or deficiency of bias during inference.

$${WeightSofmax}_{i} ( α , w ) = \frac{{w}_{i} exp ( {α}_{i} )}{{\sum }_{j = 1}^{( K + N )} {w}_{j} exp ( {α}_{j} )} \qquad ( 17 )$$

Here, w=[w₁, . . . , w_{(K+N)}] and i denote a weight vector of

$$α = [ {a}_{1}^{n} , … , {a}_{K}^{n} , {a}_{1}^{b} , … , {a}_{N}^{b} ]$$

and its index, respectively. The same bias weight μ is applied to the bias tokens as follows.

$${w}_{i} = \{ \begin{matrix}1. & ( i ≦ K ) \\ μ & ( i > K )\end{matrix} \qquad ( 18 )$$

### Other Expanded E2E-ASR Models

The above-described method of extending to accommodate bias tokens using the above-described bias list B can be applied to other E2E-ASR models including connectionist temporal classification (CTC), recurrent neural network transducer (RNN-T), and hybrids thereof.

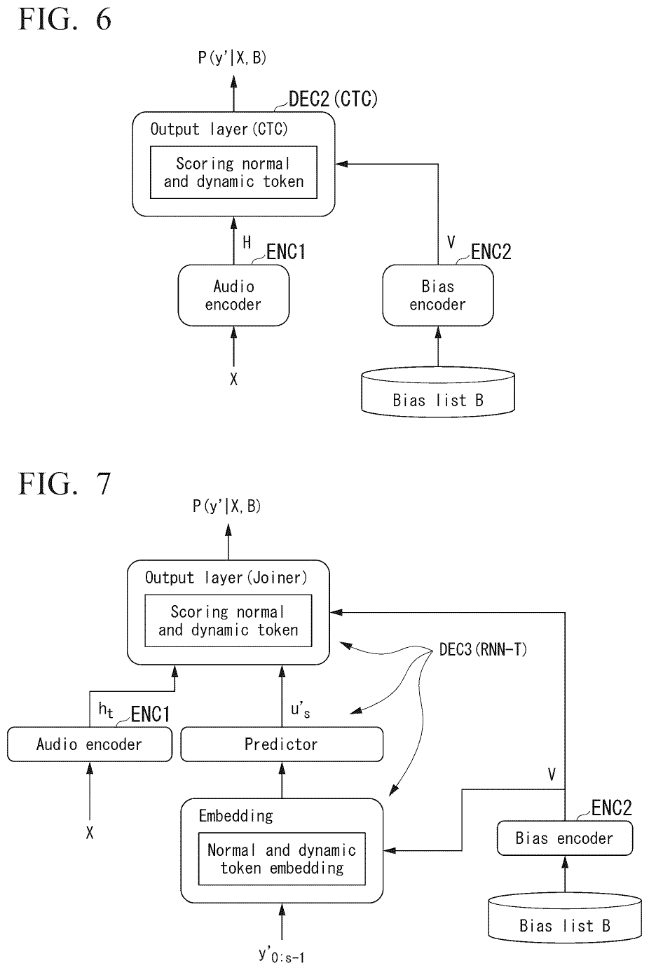

FIGS. 6 and 7 are diagrams showing other examples of the configuration of the E2E-ASR model according to the present embodiment. In FIG. 6, an example of a CTC-based E2E-ASR model is shown. The CTC-based E2E-ASR model may include, for example, a bias decoder DEC2 in addition to the audio encoder ENC1 and the bias encoder ENC2 described above. The bias decoder DEC2 is, for example, a CTC-based decoder as described in Reference Documents 3 and 4. The output layer of the bias decoder DEC2 is expanded to accommodate bias tokens as described above. The bias decoder DEC2 is another example of a “decoder.”

Reference Document 3: A. Graves, S. Fernandez, F. Gomez, and J. Schmidhuber, “Connectionist Temporal Classification: Labelling Unsegmented Sequence Data with Recurrent Neural Networks,” in Proc. ICML, 2006, pp. 369 to 376.

Reference Document 4: A. Graves and N. Jaitly, “Towards End-to-End Speech Recognition with Recurrent Neural Networks,” in Proc. ICML, 2014, pp. 1764 to 1772.

FIG. 7 shows an example of an RNN-T-based E2E-ASR model. The RNN-T based E2E-ASR model may include, for example, a bias decoder DEC3, in addition to the audio encoder ENC1 and the bias encoder ENC2 described above. The bias decoder DEC3 is an RNN-T based decoder, for example, as described in Reference Documents 5 and 6, and includes an embedding layer, a joiner, and a predictor. The embedding layer and the joiner of the bias decoder DEC3 are expanded to accommodate bias tokens as described above. The bias decoder DEC3 is another example of a “decoder.”

Reference Document 5: A. Graves, “Sequence Transduction with Recurrent Neural Networks,” in Proc. ICML, 2012.

Reference Document 6: A. Gulati et al., “Conformer: Convolution-augmented Transformer for Speech Recognition,” in Proc. Interspeech, 2020, pp. 5036 to 5040.

### Processing Flow: Training

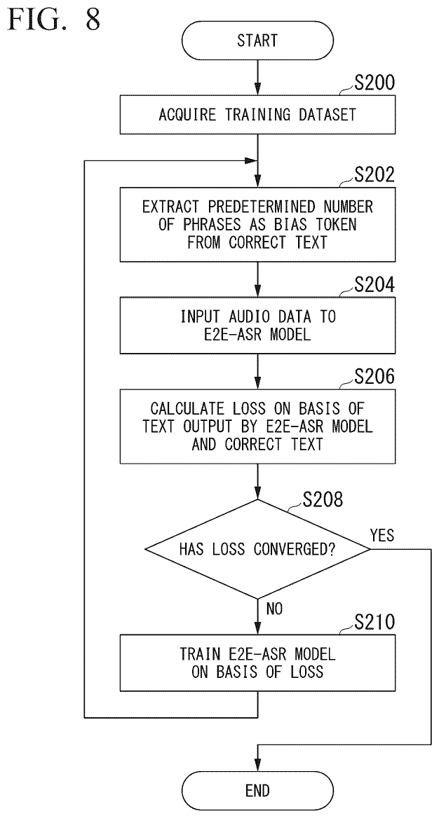

Hereinafter, a training method of the E2E-ASR model described above will be described. FIG. 8 is a flowchart showing a flow of a training process of the processing unit 140 according to an embodiment. The process of this flowchart may be iteratively executed at predetermined intervals.

First, the machine learning unit 144 acquires a training dataset (step S200).

The training dataset is, for example, a dataset in which correct text is labeled with audio data when the correct text is uttered.

Subsequently, the machine learning unit 144 randomly extracts a predetermined number of phrases from correct text included in a training dataset and registers the extracted phrases as a bias token in the bias list B (step S202). In other words, the bias list B is generated randomly.

Subsequently, the machine learning unit 144 inputs the audio data included in the training dataset to the E2E-ASR model (step S204).

Subsequently, the machine learning unit 144 calculates loss from the token sequence y_{0:s-1}=[y₀, . . . , yₛ₋₁] output by the bias decoder DEC1 of the E2E-ASR model, i.e., the text, and the correct text, on the basis of the loss function of Eq. (16) (step S206).

Subsequently, the machine learning unit 144 determines whether or not the loss has converged to a constant value (step S208) and trains the E2E-ASR model on the basis of the loss when the loss has not converged to a constant value (step S210).

Subsequently, the machine learning unit 144 returns to the processing of S202, selects correct text different from that of the previous time from the training dataset, randomly extracts a new predetermined number of phrases from the correct text, and registers them in the bias list B as bias tokens. In this way, the machine learning unit 144 changes the bias token for each utterance and trains the E2E-ASR model until the loss converges to a constant value.

On the other hand, when the loss converges to a constant value, the machine learning unit 144 ends the process of this flowchart.

According to the embodiment described above, the processing unit 140 of the speech recognition device 100 acquires audio data of an utterance and generates text from the audio data using an E2E-ASR model expanded to accommodate the bias token.

The E2E-ASR model includes the audio encoder ENC1 (an example of a “first encoder”), the bias encoder ENC2 (an example of a “second encoder”), and the bias decoder DEC1 (an example of a “decoder”).

The audio encoder ENC1 converts a feature sequence X (an example of a “first feature sequence”) in which a plurality of features of audio data are arranged into a hidden state vector sequence H (an example of a “second feature sequence”).

The bias encoder ENC2 converts a bias list B (an example of a “first token sequence”), which is a collection of a plurality of pre-registered bias tokens (an example of “first tokens”), into an embedding vector V (an example of a “third feature sequence”).

The bias decoder DEC1 estimates a token (a normal token or a bias token) following the token sequence y_{0:s-1} on the basis of the hidden state vector sequence H output by the audio encoder ENC1, the embedding vector V output by the bias encoder ENC2, and the previously estimated token sequence y_{0:s-1}.

In this way, a dynamic vocabulary in which phrase-level dynamic bias tokens have a single entity is introduced into the E2E-ASR model. Specifically, an embedding vector V derived from the bias token is introduced into the embedding layer and output layer of the bias decoder DEC1. With this configuration, it is possible to use an E2E-ASR model that can easily register words, phrases, and sentences that appear infrequently. As a result, the accuracy of speech recognition can be further improved.

Although modes for carrying out the present invention have been described above using embodiments, the present invention is not limited to the embodiments and various modifications and substitutions can also be made without departing from the scope and spirit of the present invention.

### EXAMPLE

### Experimental Setup

Hereinafter, as an example, a comparison result between the method of the present embodiment and other methods will be described. To demonstrate the adaptability of the method of the present embodiment, it was applied to offline CTC/attention (see Reference Document 7) and a streaming RNN-T model.

Reference Document 7: S. Watanabe, T. Hori, S. Kim, J. R. Hershey, and T. Hayashi, “Hybrid CTC/Attention Architecture for End-to-End Speech Recognition,” IEEE Journal of Selected Topics in Signal Processing, vol. 11, no. 8, pp. 1240 to 1253, 2017.

Features of the input audio data are 80-dimensional Mel filter banks with a window size of 512 samples and a hop length of 160 samples. Subsequently, SpecAugment is applied.

The audio encoder includes two convolutional layers with two strides, a 256-dimensional linear projection layer, and 12 conformer layers with 1024 linear units and layer normalization subsequent thereto. In the case of streaming RNN-T, the audio encoder is processed in units of blocks with a block size and look ahead of 800 ms and 320 ms.

The bias encoder includes six transformer blocks including 1024 linear units. For the bias decoder, the offline CTC/attention model includes six transformer blocks with 2048 linear units. The streaming RNN-T model includes a single long short-term memory layer. The long short-term memory layer has linear layers with a hidden size of 256 and a joint size of 320 for prediction and joint networks.

The attention layers in the audio encoder, bias encoder, and bias decoder are four multi-head attentions with a dimension d of 256. The offline CTC/attention and streaming RNN-T models have 40.58 M and 31.38 M parameters, respectively, including the bias encoders. The bias weight is set to 0.8. During training, a bias list B is randomly created for each batch with Nᵤₜₜ=[2-10] and I=[2-10]. The method of the present embodiment is trained for 150 epochs at a learning rate of 0.0025/0.002 for the CTC/attention-based model and the RNN-T-based model, respectively.

In the corpus used as the training dataset, ESPnet is used as an E2E-ASR toolkit. The method of the present embodiment is evaluated in terms of a word error rate (WER), a biased phrase WER (B-WER), and an unbiased phrase WER (U-WER). When the inserted phrase is present in the bias list B, an insertion error is counted in the B-WER. Otherwise, an insertion error is counted in the U-WER.

### Experimental Results of Offline CTC/Attention-Based Model

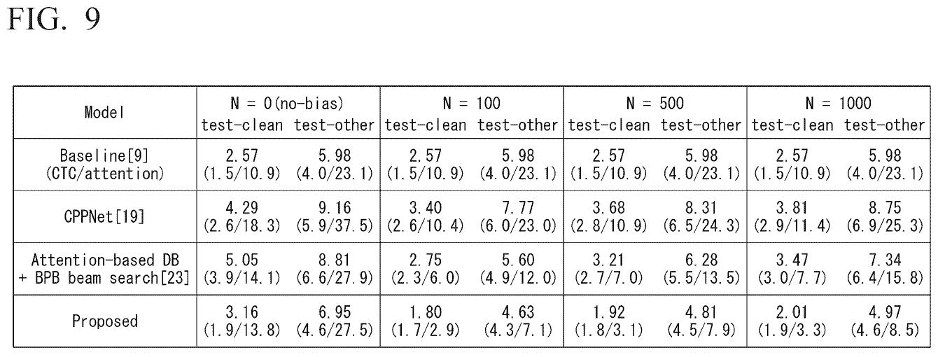

FIG. 9 shows an example of experimental results of the offline CTC/attention-based model. As shown in FIG. 9, the results of the offline CTC/attention-based model obtained on the Librispeech-960 dataset are shown for various bias list sizes N. For a bias list size N>0, the method of the present embodiment significantly improved B-WER despite the small error. The U-WER increased and the overall WER improved significantly. Although the B-WER and the U-WER tend to deteriorate as N increases, the method of the present embodiment outperformed other deep biasing (DB) techniques across all bias list sizes N. Although the method of the present embodiment did not obtain as much performance as the baseline when N=0, this is not a particularly limited disadvantage when it is considered that the user usually registers important keywords in the bias list B.

FIG. 10 shows results of a cumulative log probability defined by Eq. (15). In FIG. 10, LN1 indicates a cumulative log probability result when the bias token is used and LN2 indicates a cumulative log probability result when the bias token is not used. When the bias token is not used, the E2E-ASR model struggles to capture a relationship between subwords, resulting in significantly lower scores for each subword. In contrast, as in the method of the present embodiment, when the bias token is used, a higher score is assigned to the bias token (<Nelly>), improving the B-WER (see FIG. 9). The log probabilities before and after the bias token (<fresh>and <is>) are stable. This indicates that the method of the present embodiment successfully maintains the context throughout the token sequence.

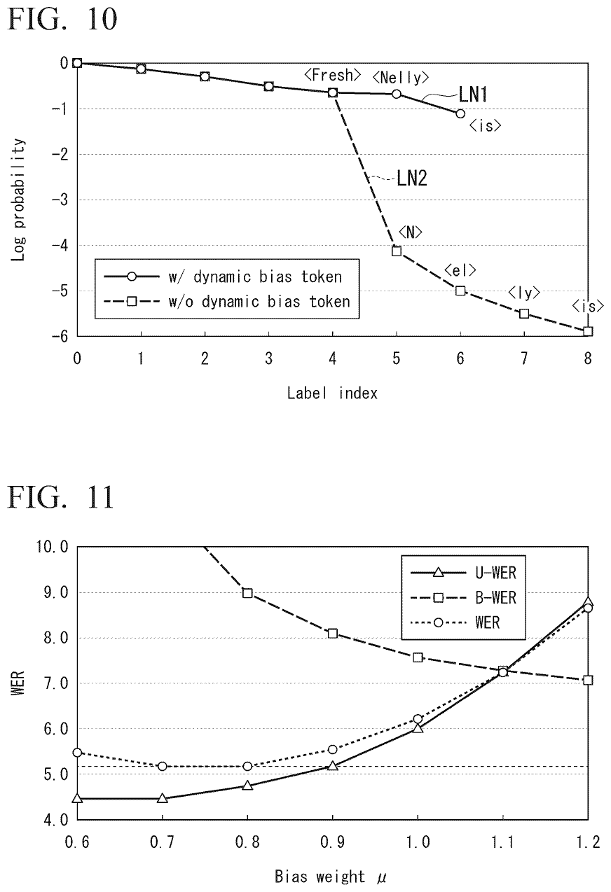

FIG. 11 is a diagram showing results of the effect of the bias weight μ. In the example shown in FIG. 11, the effect of the bias weight u on the results of a WER, a U-WER, and a B-WER when the bias list size N=2000 is shown. Increasing the bias weight μ improves the B-WER, but deteriorates the U-WER due to the tendency for overbiasing. Under this experimental condition, when the bias weight μ is not introduced, there is a slight tendency for overbiasing. Thus, when μ=0.8, the overbiasing can be suppressed. Because the degree to which the model is biased depends on the target user domain, it is effective to be able to easily adjust the bias weight u during inference.

Moreover, using the above-mentioned attention-based model, the method of the present embodiment was verified using the spontaneous Japanese corpus (581 hours), the Japanese speech database (181 hours) developed by the Advanced Telecommunications Research Institute International, and Japanese speech data (93 hours) including meeting and morning assembly scenarios.

FIG. 12 shows results when N(=203) technical terms are registered in the bias list B. Although the method of the present embodiment slightly deteriorates an unbiased character error rate (U-CER), it significantly improves a biased character error rate (B-CER) and provides the best overall CER.

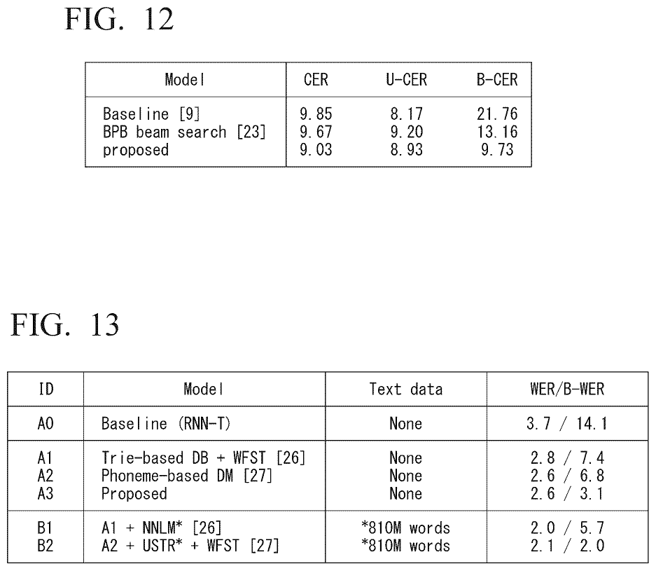

FIG. 13 shows results of the streaming RNN-T-based model using a bias list of size N=100. Consistent with the results of the offline CTC/attention-based model (FIG. 9), the method of the present embodiment significantly improves the B-WER compared to the conventional DB method without relying on additional information such as phonemes, while maintaining an overall WER comparable to those of conventional DB approaches (A1-2 vs. A3). Furthermore, the conventional DB method significantly improves the B-WER with additional text data (A1-2 vs. B1-2), whereas the method of the present embodiment achieves an equivalent B-WER without such additional data (A3vs. B1-2).

What is claimed is:

1. A speech recognition device comprising:
an acquisition unit configured to acquire audio data of an utterance; and
a speech recognition unit configured to generate text from the audio data using an automatic speech recognition model,
wherein the automatic speech recognition model includes
a first encoder configured to convert a first feature sequence in which features of the audio data are arranged into a second feature sequence;
a second encoder configured to register any one or a combination of pre-registered words, phrases, and sentences as a first token and convert a first token sequence in which first tokens are arranged into a third feature sequence; and
a decoder expanded to correspond to the first token and configured to estimate the second token or the first token following a second token sequence in which at least one of the first token and a second token different from the first token previously estimated as the text is arranged on the basis of the second feature sequence, the third feature sequence, and the second token sequence.

2. The speech recognition device according to claim 1,
wherein the decoder has an embedding layer expanded to correspond to the first token, and
wherein the embedding layer
determines whether or not the second token sequence includes the first token,
converts the second token sequence into a fourth feature sequence when the second token sequence does not include the first token, and
converts the remaining second token sequence, excluding the first token, into the fourth feature sequence when the second token sequence includes the first token, and generates a fifth feature sequence by concatenating a third feature corresponding to the first token included in the second token sequence among a plurality of third features included in the third feature sequence and the fourth feature sequence after conversion of the remaining second token sequence, excluding the first token.

3. The speech recognition device according to claim 2,
wherein the decoder has an output layer expanded to correspond to the first token, and
wherein the output layer
converts the fourth feature sequence or the fifth feature sequence into a sixth feature sequence,
calculates a first score that is a score of the first token on the basis of an inner product of the sixth feature sequence and the first token sequence,
calculates a second score that is a score of each of the second tokens included in the second token sequence, and
calculates a probability of the second token or the first token following the second token sequence on the basis of the first score and the second score.

4. The speech recognition device according to claim 1, further comprising an input interface capable of being manipulated by a user,
wherein the speech recognition unit registers any one or a combination of the words, phrases, and sentences input by the user to the input interface as the first token.

5. A speech recognition method using a computer, comprising:
acquiring audio data of an utterance; and
generating text from the audio data using an automatic speech recognition model,
wherein the automatic speech recognition model includes
a first encoder configured to convert a first feature sequence in which features of the audio data are arranged into a second feature sequence;
a second encoder configured to register any one or a combination of pre-registered words, phrases, and sentences as a first token and convert a first token sequence in which first tokens are arranged into a third feature sequence; and
a decoder expanded to correspond to the first token and configured to estimate the second token or the first token following a second token sequence in which at least one of the first token and a second token different from the first token previously estimated as the text is arranged on the basis of the second feature sequence, the third feature sequence, and the second token sequence.

6. A non-transitory storage medium storing a program for causing a computer to:
acquire audio data of an utterance; and
generate text from the audio data using an automatic speech recognition model,
wherein the automatic speech recognition model includes
a first encoder configured to convert a first feature sequence in which features of the audio data are arranged into a second feature sequence;
a second encoder configured to register any one or a combination of pre-registered words, phrases, and sentences as a first token and convert a first token sequence in which first tokens are arranged into a third feature sequence; and
a decoder expanded to correspond to the first token and configured to estimate the second token or the first token following a second token sequence in which at least one of the first token and a second token different from the first token previously estimated as the text is arranged on the basis of the second feature sequence, the third feature sequence, and the second token sequence.
